(19) United States
(12) Patent Application Publication
(10) Pub. No.: US 2024/0066742 A1
(43) Pub. Date: Feb. 29, 2024

(54) CHAINSAWS HAVING CHAIN TENSIONING BIASING ELEMENTS

(71) Applicant: Milwaukee Electric Tool Corporation, Brookfield, WI (US)

(72) Inventor: Ryan Kinney, Brookfield, WI (US)

(21) Appl. No.: 18/235,145

(22) Filed: Aug. 17, 2023

Related U.S. Application Data
(60) Provisional application No. 63/402,221, filed on Aug. 30, 2022.

(51) Int. Cl. B27B 17/14; B27B 17/02

(52) U.S. Cl. CPC B27B 17/14; B27B 17/02; B27B 17/083

(57) ABSTRACT

Chainsaws having chain tensioning biasing elements are provided. A chainsaw includes a housing comprising a geartrain; a guide bar extending from the housing; a chain moveably coupled around the geartrain and the guide bar; a motive device operatively coupled to the geartrain that selectively drives the geartrain to cause rotational movement of the chain around the guide bar; a tension adjustment assembly configured to selectively move the guide bar relative to the housing to adjust a tension in the chain; and a tension biasing element that continuously imparts an expansive force on the guide bar and/or the chain to oppose a loosening of the tension in the chain.

### CROSS-REFERENCE TO RELATED APPLICATIONS

The present application claims priority to U.S. Provisional Patent Application Ser. No. 63/402,221 filed on Aug. 30, 2022, the disclosure of which is incorporated by reference herein in its entirety.

### FIELD

The present disclosure relates generally to power tools, and more particularly to chainsaws having tension biasing elements that oppose the loosening of tension in a chain.

### BACKGROUND

Power tools are generally utilized in lieu of hand tools. Power tools can perform the same, or similar, tasks as hand tools at higher efficiency, allowing the operator controlling the power tool to use less effort in achieving a task. For example, chainsaws can cut through wood faster than traditional handsaws.

Higher efficiency and performance may be achieved by using a motive device, such as a gas engine or electric motor, to drive a working implement of the power tool. These engines and motors can generally be operable at variable speeds controlled by the operator through an actuator. For example, chainsaws move a chain about a guide bar at increasing speeds as the actuator is further depressed. In order to facilitate the installation and removal of the chain with respect to the chainsaw, including performing maintenance operations thereon, the tension in the chain can be selectively increased and decreased. For example, before operation, the tension in the chain can be increased to assist with cutting performance and limit slippage. Likewise, after operation, the tension may be released to facilitate removal of the chain or maintenance thereon. The tension in the chain may therefore be adjustable by one or more control mechanisms. However, even when a threshold tension is obtained, operation or other residual forces may impact the stability of the tension in the chain.

Accordingly, improved power tools which can resist loosening of the tension in that chain are desired in the art. In particular, chainsaws which provide adjustable tension in the chain along with a tension biasing force that stabilizes a tension once set would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a chainsaw is provided. The chainsaw includes a housing comprising a geartrain; a guide bar extending from the housing; a chain moveably coupled around the geartrain and the guide bar; a motive device operatively coupled to the geartrain that selectively drives the geartrain to cause rotational movement of the chain around the guide bar; a tension adjustment assembly configured to selectively move the guide bar relative to the housing to adjust a tension in the chain; and a tension biasing element that continuously imparts an expansive force on the guide bar and/or the chain to oppose a loosening of the tension in the chain.

In accordance with another embodiment, another chainsaw is provided. The chainsaw includes a housing comprising a geartrain; a guide bar extending from the housing, the guide bar comprising an outer track comprising a first wall opposite a second wall, and a bottom wall extending between the first wall and the second wall; a chain moveably coupled around the geartrain and the outer track of the guide bar; a motive device operatively coupled to the geartrain that selectively drives the geartrain to cause rotational movement of the chain around the guide bar; and a tension adjustment assembly configured to selectively move the guide bar relative to the housing to adjust a tension in the chain. The tension adjustment assembly includes a pin extending away from the housing and through an aperture in the guide bar; a worm gear threadably coupled to the pin; and an adjustment gear configured to selectively rotate the worm gear to move the pin relative to the housing. The chainsaw further includes a tension biasing element that imparts an expansive force pushing the guide bar away from the housing to oppose a loosening of the tension in the chain.

In accordance with yet another embodiment, a guide bar for a chainsaw is provided. The guide bar includes an elongated body extending from a first end to a second end; an outer track disposed about the elongated body, wherein the outer track comprises a first wall opposite a second wall, and a bottom wall extending between the first wall and the second wall; and a tension biasing element disposed in the outer track, wherein the tension biasing element is configured to provide an expansive force between a chain and the bottom wall when the chain is disposed around the guide bar in the outer track to oppose a loosening of a tension in the chain.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a first side perspective view of a chainsaw in accordance with embodiments of the present disclosure;

FIG. 2 is second side perspective view, opposite of the first side perspective view, of the chainsaw of FIG. 1 in accordance with embodiments of the present disclosure;

FIG. 3 is a perspective view of a portion of a motive device in accordance with embodiments of the present disclosure;

FIG. 4 is a side view of the chainsaw of FIG. 1 with a portion of a housing removed and including a tension biasing element in accordance with embodiments of the present disclosure;

FIG. 5 is a side view of the chainsaw of FIG. 4 illustrating a chain brake in a released state in accordance with embodiments of the present disclosure;

FIG. 6 is a side view of the chainsaw of FIG. 4 illustrating a chain brake in a brake state in accordance with embodiments of the present disclosure;

FIG. 7 is a perspective view of a cover assembly of the chainsaw in accordance with embodiments of the present disclosure;

FIG. 8 is a cross sectional view of the cover assembly along line 8-8 of FIG. 1 in accordance with embodiments of the present disclosure;

FIG. 9 is a side perspective view of the chainsaw with another tension biasing element in accordance with embodiments of the present disclosure; and

FIG. 10 is cross sectional view of an outer track of the guide bar in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof are intended to cover a non-exclusive inclusion. For example, a process, method, article, or apparatus that comprises a list of features is not necessarily limited only to those features but may include other features not expressly listed or inherent, to such process, method, article, or apparatus. Further, unless expressly stated to the contrary, “or” refers to an inclusive- or and not to an exclusive- or. For example, a condition A or B is satisfied by any one of the following: A is true (or present) and B is fake (or not present), A is fake (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

As used herein, the term “power tool” is intended to refer to a device which is used to perform a work operation, such as cutting materials like wood, metal, concrete, grass, or the like; trimming objects like branches; biasing fluids like air and water; and the like. By way of non-limiting example, power tools can include chainsaws or other devices that use a cutting chain that rotates around one or more components.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, a power tool in accordance with one or more embodiments described herein can generally include a chain that rotates around one or more elements. The power tool can include a tension adjustment assembly that allows for the increasing and decreasing of tension in the chain. The power tool can further include a tension biasing element that provides an expansive force one the chain and/or one or more components that support the chain. The expansive force provided by the tension biasing element can thereby continuously resist the loosening of tension in the chain.

By way of non-limiting example, the power tool can be a chainsaw. The chainsaw can include a motive device and a chain. The chain can be moveably coupled around the guide bar and a geartrain that is driven by the motive device. A tension adjustment assembly can be configured to move the guide bar relative to the housing to facilitate the initial adjustment of tension in the chain. A tension biasing element is further provided to continuously impart an expansive force on the chain, the guide bar, or combinations thereof. In this regard, the tension biasing element opposes a loosening of the tension in the chain by resisting slippage or other movement of components that would decrease tension. As a result, tension in the chain that is initially adjusted by an operator can be better stabilized throughout operation of the chainsaw. These and other advantages will become apparent to one of ordinary skill in the art after reading the entire disclosure.

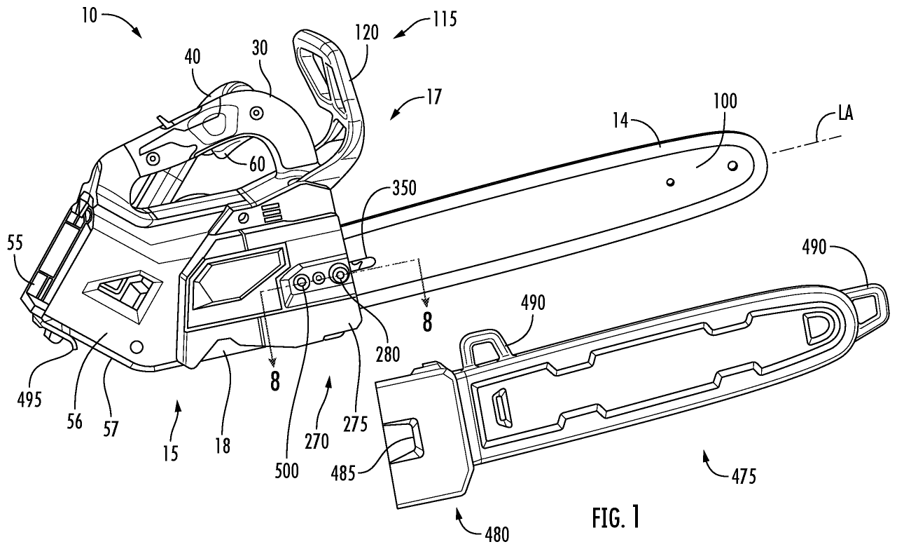

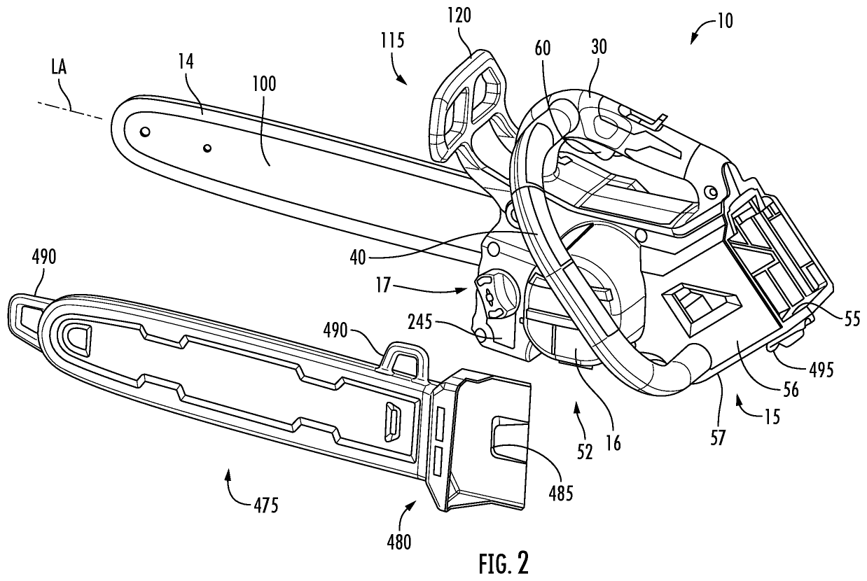

Referring now to the drawings, FIG. 1 illustrates a first side perspective view of a power tool in accordance with an exemplary embodiment of the present disclosure, while FIG. 2 illustrates a second, and opposite, side perspective view of the power tool illustrated in FIG. 1.

More particularly, FIGS. 1 and 2 illustrate a chainsaw 10 in accordance with an embodiment of the present disclosure. The chainsaw 10 generally includes a housing 15 that extends between a first side 16 and second side 18 and comprises a geartrain 110. The chainsaw further includes a guide bar 100 comprising an elongated body that extends from a front portion 17 of the housing 15, and a chain 14 that is movably coupled around the geartrain 110 and the guide bar 100 (e.g., via an outer track 102). The chain 14 includes teeth which, when moved along the guide bar 100, cause the chain 14 to cut into material, such as logs and branches.

The chainsaw 10 can include a variety of features and configurations to facilitate the handling and operation of the chainsaw 10 by a user. For instance, as illustrated in FIGS. 1 and 2, the housing 15 includes a first handle 30 (e.g., a top handle) coupled between a battery pack receiving receptacle 55 and the front portion 17 of the housing 15. As such, the first handle 30 extends in a direction along the longitudinal axis LA of the guide bar 100. In addition, the housing 15 includes a second handle 40 (e.g., an elongated curved bar) coupled between the first handle 30 and a sidewall 56 of the battery pack receiving receptacle 55. The illustrated second handle 40 extends beyond a first side 16 of the housing 15 and includes a central axis that is generally U-shaped.

The first handle 30 includes an actuator 60 operable to actuate the drive state of a motive device 50. That is, when depressed, the actuator 60 can engage the motive device 50 to rotate the chain 14 by causing one or more gears in a geartrain 110 to spin. As the actuator 60 is depressed further, a speed of the motive device 50 can increase from zero speed to a maximum speed. In this regard, the actuator 60 may variably affect the speed of the motive device 50 between a stopped speed, which occurs when the actuator 60 is not depressed, and a maximum speed, which occurs when the actuator 60 is fully depressed.

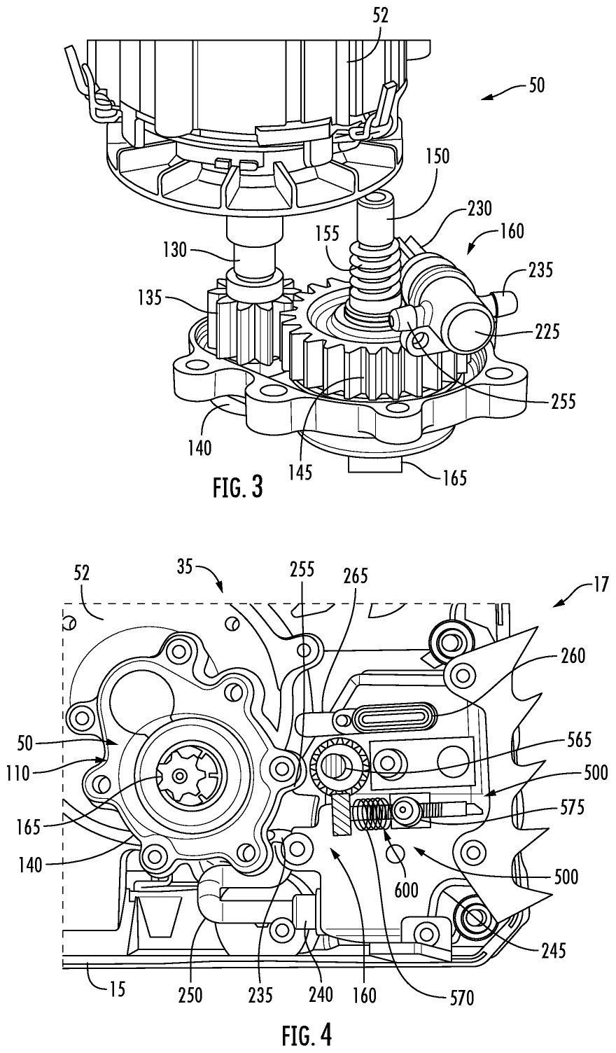

The motive device 50 comprises any generational source of power to directly, or indirectly, move the chain 14 around the guide bar 100. That is, the motive device 50 can be operatively coupled to the geartrain 110 to selectively drive the geartrain 110 and cause rotational movement of the chain 14 around the guide bar 100. For instance, in some embodiments, the motive device 50 may comprise a gas powered engine (not illustrated). In some embodiments, such as that illustrated in FIGS. 3 and 4, the motive device 50 can comprise an electric motor 52. The electric motor 52 can be positioned in any suitable location within or about the housing 15 that facilitates an operational connection with the chain 14. For instance, the electric motor 52 can be positioned on the first side 16 of the housing 15 coupled to the second handle 40 as illustrated in FIG. 2.

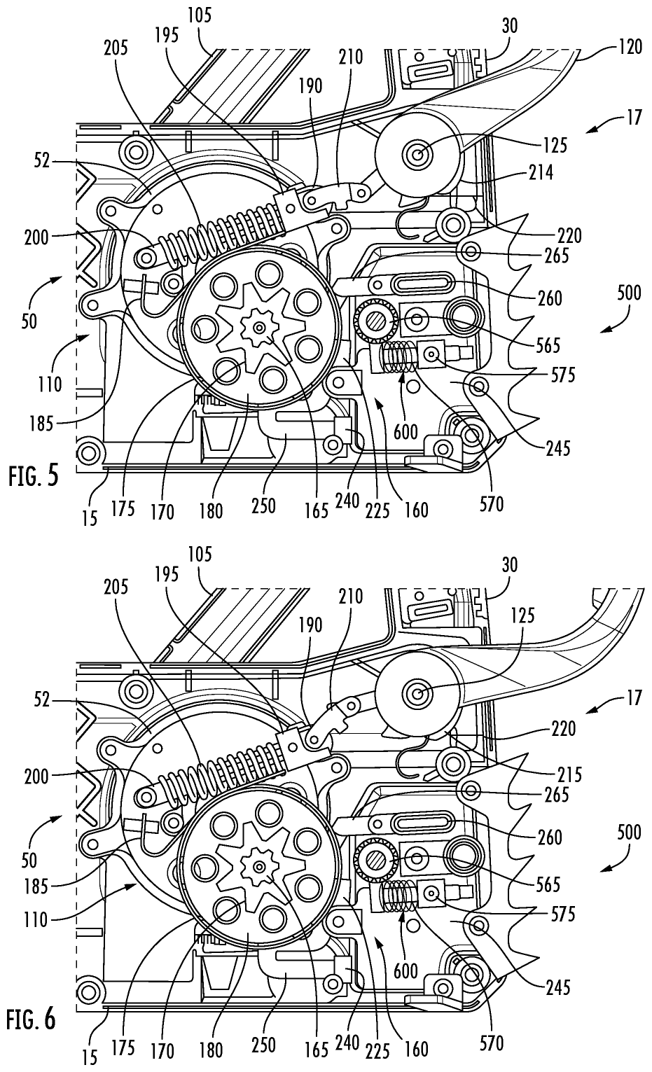

As illustrated in FIG. 3, the electric motor 52 includes a motor shaft 130 that drives one or more gears of the geartrain 110. For instance, the motor shaft 130 can drive a first spur gear 135 about a rotational axis of the motor shaft 130. The first spur gear 135 is rotatably supported by the motor shaft 130 and an outer geartrain casing 140. The first spur gear 135 engages a second spur gear 145, which includes a greater diameter than the first spur gear 135. The second spur gear 145 is at least partially supported by the outer geartrain casing 140. In turn, the second spur gear 145 drives a drive shaft 150 with an inboard side of the drive shaft 150 having a worm gear 155 that engages an optional lubricant system 160 and an outboard side 165 of the drive shaft 150 extending beyond the outer geartrain casing 140. With reference to FIGS. 4 and 5, the outboard side 165 of the drive shaft 150 drives an output spindle 170. The output spindle 170 engages the chain 14. Accordingly, the electric motor 52 drives the chain 14 around the guide bar 100 by the output spindle 170.

The chainsaw 10 may further include one or more brake mechanisms to stop movement of the chain 14 and/or operation of the motive device 50 (e.g., the electric motor 52). For example, as illustrated, the chainsaw 10 further includes a chain brake 115 having a handguard 120 pivotably coupled to the front portion 17 of the housing 15 about a handguard pivot axis 125. The handguard 120 can be located between the guide bar 100 and a front portion of the first handle 30. The chain brake 115 is thus operable to stop the movement of the chain 14 and/or operation of the electric motor 52 (or other motive device 50), such as during a kickback event as discussed in more detail below.

With reference to FIGS. 5 and 6, the output spindle 170 is coupled to the chain brake 115 such that the chain brake 115 is operable to stop rotation of the output spindle 170, which ultimately stops movement of the chain 14 relative to the guide bar 100. As illustrated, the chain brake 115 includes a flexible band 175 extending around a drum 180 of the output spindle 170. A first end 185 of the flexible band 175 is fixed to the housing 15 and a second end 190 of the flexible band 175 is coupled to a first linkage 195 of the chain brake 115. The first linkage 195 is coupled to a support 200 by a compression spring 205 and the support 200 is fixed to the housing 15. The compression spring 205 biases the first linkage 195 away from the support 200. The first linkage 195 is also coupled to the handguard 120 by a second linkage 210 pivotably coupled between the first linkage 195 and the handguard 120.

The chain brake 115 is movable between a released state, as illustrated in FIG. 5, and a brake state, as illustrated in FIG. 6. In the released state, the handguard 120 is in an upright position for the handguard 120 to position the first linkage 195 relative to the support 200 to compress the compression spring 205 between the support 200 and the first linkage 195. As such, the second end 190 of the flexible band 175 is positioned relative to the first end 185 of the flexible band 175 such that the flexible band 175 around the drum 180 flexes radially outwardly to be spaced from the drum 180 of the output spindle 170. In the illustrated embodiment, the second linkage 210 is oriented in an over-center manner relative to the first linkage 195 when in the released state. As such, the biasing force of the compression spring 205 acts to maintain the handguard 120 in the upright position when in the released state (e.g., the compression spring 205 biases the handguard 120 in the counterclockwise direction in the reference frame of FIG. 5). Accordingly, the output spindle 170 can be driven by the electric motor 52 without interference from the flexible band 175.

In the brake state (FIG. 6), the handguard 120 is pivoted into a lowered position (e.g., during a kickback event). In particular, the handguard 120 pivots the second linkage 210 relative to the first linkage 195 (e.g., out of the over-center configuration) allowing the first linkage 195 to move toward the handguard pivot axis 125 of the handguard 120 by the biasing force of the compression spring 205. Movement of the first linkage 195 also moves the second end 190 of the flexible band 175 away from the first end 185 of the flexible band 175. As a result, the flexible band 175 engages the drum 180 of the output spindle 170 and provides a frictional force between the flexible band 175 and the drum 180 to stop rotation of the output spindle 170. In some embodiments, the handguard 120 is engageable with a switch when in the lowered position for the switch to deactivate power to the electric motor 52 to assist the flexible band 175 in stopping movement of the output spindle 170.

In order for the electric motor 52 to drive the output spindle 170 again, the handguard 120 can be pivoted back into the upright position (FIG. 5) by the operator. A protrusion 215 that extends from the handguard 120 engages a biasing member 220 coupled to the housing 15 to provide positive feedback to the operator that the handguard 120 is in the upright position. In some embodiments, the engagement between the protrusion 215 and the biasing member 220 helps maintain the handguard 120 in the upright position when in the released state.

With reference back to FIG. 3, the chainsaw 10 can further include the lubricant system 160 for lubricating the chain intermittently, periodically, or continuously during operation. As illustrated, the lubricant system 160 includes a pump 225 having a spur gear 230 engageable with the worm gear 155 of the drive shaft 150. As shown in FIG. 4, the pump 225 includes an inlet port 235 coupled to an outlet 240 of a lubricant reservoir 245 by a first conduit 250. The illustrated outlet 240 is coupled to a bottom portion of the lubricant reservoir 245. The pump 225 also includes an outlet port 255 positioned opposite the inlet port 235. The outlet port 255 is coupled to a nozzle 260 by a second conduit 265. The illustrated nozzle 260 is coupled to a second side 18 of the housing 15 opposite the first side 16. Accordingly, the electric motor 52 drives the lubricant system 160 by the drive shaft 150 for the pump 225 to eject a lubricant (e.g., cutting chain oil) within the lubricant reservoir 245 from the nozzle 260. The nozzle 260 is positioned adjacent the guide bar 100 and the chain 14 to dispense the lubricant on the chain 14 during operation.

In the illustrated embodiment, the lubricant system 160 is non-adjustable. However, in other embodiments, the lubricant system 160 can be manually adjustable to regulate an amount/rate of lubricant being pumped to the chain 14. For example, an adjustable lubricant pump system can include a pump shaft that rotates and reciprocates within a pump body and a cam shaft that engages the pump shaft to limit a stroke length of the pump shaft as the pump shaft reciprocates. The operator can then adjust the cam shaft causing an increase or a decrease in the stroke length of the pump shaft and a resultant change in the oil output of the adjustable lubricant pump system.

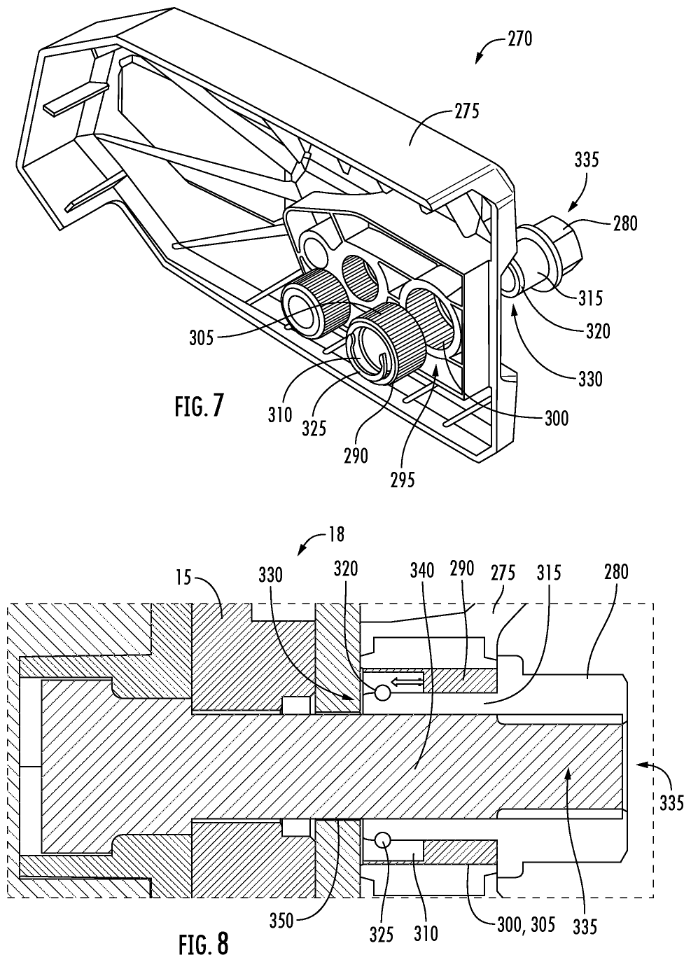

The guide bar 100 and chain 14 are generally detachably coupled to the housing 15 of the chainsaw 10 such that that are firmly affixed during operation, but may be selectively removed at other times for maintenance or replacement operations. For instance, in some embodiments, such as that illustrated in FIG. 1, the guide bar 100 and the chain 14 are selectively coupled to the second side 18 of the housing 15 by a cover assembly 270 (FIG. 1). With reference to FIGS. 7 and 8, a cover assembly 270 of the housing 15 includes a cover 275 having a captured nut 280 that engages a stud 285 fixed to the second side 18 of the housing 15 to secure the guide bar 100 and the chain 14 to the second side 18. The captured nut 280 can remain coupled (e.g., inseparable) to the cover 275 by an insert 290. As shown in FIG. 7, an aperture 295 of the cover 275 includes inwardly protruding ribs 300 that mesh with corresponding outwardly protruding ribs 305 of the insert 290 to prevent rotation of the insert 290 relative to the cover 275. In addition, the insert 290 is axially fixed within the aperture 295. The illustrated insert 290 includes an interior channel 310 defined in an inner surface thereof. FIG. 7 illustrates two inserts 290 each associated with a stud 285. In other embodiments, the cover assembly 270 can include one stud 285 and one insert 290.

As shown in FIGS. 7 and 8, the captured nut 280 includes a shank 315 having an exterior channel 320 defined therein. The captured nut 280 also includes a retainer 325 (e.g., a split ring) positioned within the exterior channel 320 of the shank 315. The retainer 325 is received within the interior channel 310 of the insert 290 such that the captured nut 280 can freely rotate relative to the insert 290 and the cover 275. The captured nut 280, however, is limited in axial travel relative to the insert 290. Specifically, the captured nut 280 is limited in outboard travel relative to the second side 18 by the retainer 325 engaging the interior channel 310, and the captured nut 280 is limited in inboard travel relative to the second side 18 by a head of the captured nut 280 engaging an outer surface of the cover 275. As such, the captured nut 280 can axially move relative to the cover 275 within a determined range. In other embodiments, the captured nut 280 can include different features to limit movement of the captured nut 280 relative to the insert 290. For example, the exterior channel 320 and the retainer 325 can be replaced with an integral flange extending from the shank 315. As shown in FIG. 8, the captured nut 280 includes an inner bore having a proximal portion 330 that is positioned closer to the second side 18 of the housing 15 than a distal portion 335 of the captured nut 280. In some embodiments, the proximal portion 330 can include threads, and the distal portion 335 can be a non-threaded portion. In other embodiments, the proximal portion 330 can be a non-threaded portion, and the distal portion 335 can include threads. In further embodiments, both the proximal portions 330 and the distal portions 335 can include threads.

In the illustrated embodiment, the stud 285 includes a proximal portion 340 adjacent the second side 18 of the housing 15 and a distal portion 345 opposite the proximal portion 340. In some embodiments, both the proximal portions 340 and the distal portions 345 of the stud 285 can include threads. In other embodiments, the proximal portion 340 can include threads, and the distal portion 345 can be a non-threaded portion. In further embodiments, the proximal portion 340 can be a non-threaded portion, and the distal portion 345 can include threads.

To secure the guide bar 100 to the second side 18 of the housing 15, the guide bar 100 is positioned relative to the stud 285 such that the stud 285 extends through a slot 350 of the guide bar 100. The cover 275 is then placed over the stud 285 and the guide bar 100 such that the stud 285 aligns with the aperture 295 of the cover 275. In some embodiments, the stud 285 extends completely through the aperture 295 and the insert 290, the stud 285 may partially extend within the aperture 295 and the insert 290, or the stud 285 may not extend within the aperture 295 and the insert 290 when the cover 275 is coupled to the lateral side. Placement of the cover 275 over the stud 285 automatically aligns the nut 280 with the stud 285. In particular, the distal portion 345 of the stud 285 is axially received within the proximal portion 330 of the captured nut 280 without threaded engagement therebetween. Accordingly, the captured nut 280 can axially slide onto the stud 285 to align the captured nut 280 with the stud 285, and then the captured nut 280 can be threadably rotated onto the stud 285 to secure the cover 275 and the guide bar100 to the second side 18 of the housing 15.

In one embodiment, the proximal portion 340 of the stud 285 can include threads, and at least the proximal portion 330 of the captured nut 280 can include threads. Accordingly, the threaded proximal portion 330 of the captured nut 280 can slide past the non-threaded distal portion 345 of the stud 285 to align the captured nut 280 with the stud 285, and then the threaded proximal portion 330 of the captured nut 280 engages the threaded proximal portion 340 of the stud 285 to secure the cover 275 to the second side 18. In another embodiment, the distal portion 345 of the stud 285 can include threads, and the distal portion 335 of the captured nut 280 can include threads. Accordingly, the non-threaded proximal portion 330 of the captured nut 280 can slide past the threaded distal portion 345 of the stud 285 to align the captured nut 280 with the stud 285, and then the threaded distal portion 335 of the captured nut 280 engages the threaded distal portion 345 of the stud 285 to secure the cover 275 to the second side 18.

The chainsaw 10 can further comprise a tension adjustment assembly 500 to adjust a tension of the chain 14 on the guide bar 100. The tension adjustment assembly 500 can be configured to selectively move the guide bar 100 relative to the housing 15 to adjust the tension in the chain.

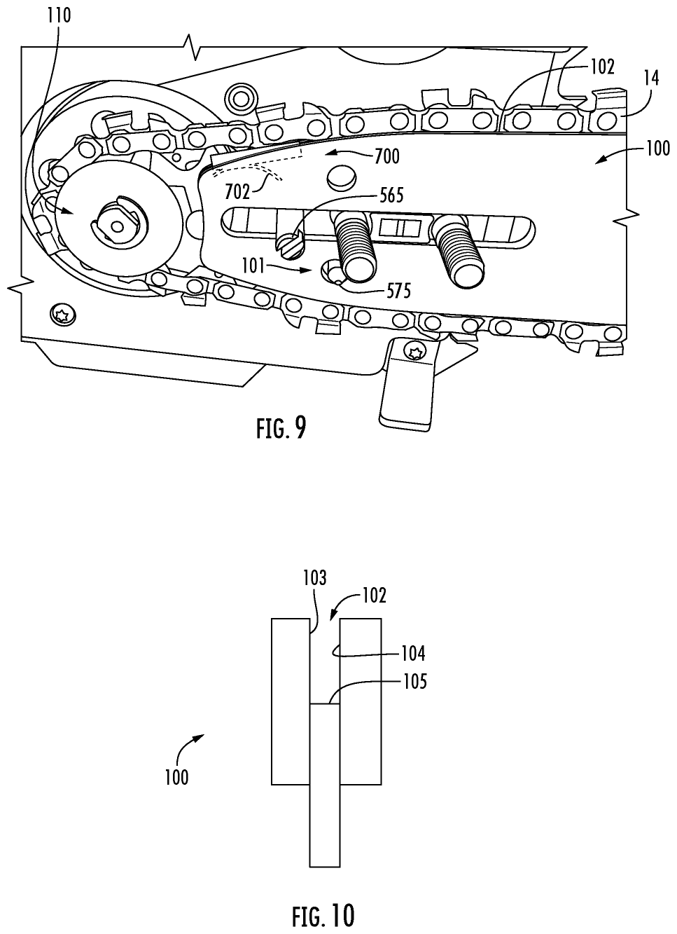

For instance, with reference to FIGS. 4-6, the illustrated tension adjustment assembly 500 includes an adjustment gear 565 that drives a worm gear 570 that is threadably coupled to a pin 575. The adjustment gear 565 extends through the slot 350 of the guide bar 100 and the cover 275 when the cover assembly 270 is coupled to the second side 18 (FIG. 1) such that the tension of the chain 14 can be adjusted when the cover assembly 270 is coupled to the housing 15. The pin 575 is received within an aperture 101 (FIG. 9) of the guide bar 100 positioned below the slot 350 of the guide bar 100. As such, rotation of the adjustment gear 565 configured to provide selective movement (e.g., linear movement) of the pin 575 relative to the housing 15 for the pin 575 to move the guide bar 100 relative to the housing 15 to tighten or loosen the chain 14 on the guide bar 100. That is, rotation of the adjustment gear 565 in one direction can move the pin 575 such that the guide bar 100 is moved further away from the housing 15, which in turn would add tension in the chain 14. Likewise, rotation of the adjustment gear 565 in the opposite direction can move the pin 575 such that the guide bar 100 is moved closer to the housing 15, which in turn would release tension in the chain 14. The tension adjustment assembly 500 can allow for the selective increasing and decreasing of tension in the chain 14, so that various chains 14 of different lengths can compensated for prior to operation of the chainsaw 10.

Still referring to FIGS. 4-6, the chainsaw 10 can further include a tension biasing element 600. The tension biasing element 600 comprises a device configured to continuously impart an expansive force on the guide bar 100 and/or the chain 14 to thereby oppose a loosening of the tension in the chain 14. By preventing, resisting, or otherwise inhibiting the compaction of respective components, the tension biasing element 600 counters potential slippage or other forces that may slowly or suddenly cause the tension in the chain 14 to decrease. As a result, the chain 14 can be better maintained in a sufficiently taught state to maintain performance during cutting operations.

The tension biasing element 600 can comprise a variety of different materials and/or configurations to impart the expansive force on the guide bar 100 and/or chain 14. For instance, as illustrated in FIGS. 4-6, the tension biasing element 600 can be disposed in the tension adjustment assembly 500. That is, the tension biasing element 600 can be disposed between the pin 575 and an end of the worm gear 570 within the tension adjustment assembly 500. As such, the continuous expansive force provided by the tension biasing element 600 can resist slippage of the pin 575 back towards the end of the worm gear 570. Thus, even as outside forces may be applied on the chain 14 (such as during cutting operations), the tension biasing element 600 would provide a force that is resistive to the compaction of respective elements of the tension adjustment assembly 500 to help maintain the original tension in the chain 14.

While FIGS. 4-6 illustrate the tension biasing element 600 being disposed around the worm gear 570 (between one end of the worm gear 570 and the pin 575), it should be appreciated that the tension biasing element 600 may alternatively, or additionally, be provided in various other locations about the tension adjustment assembly 500. For instance, the tension biasing element 600 may be disposed adjacent the adjustment gear 565 to oppose rotational movement of the adjustment gear 565 that would loosen the tension in the chain 14. Likewise, the tension biasing element 600 may be disposed in a different configuration that, while still applying pressure on at least one of the pin 575 or the worm gear 570, may not be disposed directly between the two elements such that the tension biasing element 600 does not simultaneously apply its expansive force on both the pin 575 and the worm gear 570.

In some embodiments, such as that illustrated in FIGS. 4-6, the tension biasing element 600 can comprise a compressive spring which provides an inherent outwardly expansive force when partially or fully compressed. The compressive spring can have a spring constant that is selected to provide an expansive force to oppose loosening of the tension in the chain 14, yet still capable of being overcome by an operator when seeking to loosen the tension for repair or maintenance operations. In some embodiments, the tension biasing element 600 can comprise an elastomeric material, such as rubber. As such, the elastomeric material may be able to be partly compressed between two components, and thereby provide an expansive force between the two components while partially compressed. In even some embodiments, the tension biasing element 600 can comprise another suitable material for providing an expansive force, such as a suitable foam, polymer, or other material that when compressed or bent in a certain way provides an expansive force to return to its original state.

Referring now to FIGS. 9 and 10, another tension biasing element 700 is illustrated for providing an expansive force to oppose loosening of the tension in the chain 14. As illustrated in FIGS. 9 and 10, the tension biasing element 700 can be disposed in the guide bar 100 to push the chain 14 away from the guide bar 100 (and thereby oppose loosening of the tension). For instance, as illustrated in FIG. 10, the outer track 102 of the guide bar 100 can comprise a first wall 103 opposite a second wall 104. A bottom wall 105 can extend between the first wall 103 and the second wall 104. As illustrated in FIG. 9 (via dashed lines), the tension biasing element 700 may be disposed within the outer track 102 between the bottom wall 105 and the chain 14. As such, the tension biasing element 700 can provide an expansive force between the bottom wall 105 and the chain 14 to push the chain 14 away from the bottom wall 105, thereby adding tension into the chain 14 and opposing a loosening thereof.

In such embodiments, the tension biasing element 700 can comprise a variety of configurations to provide the expansive force. For instance, the tension biasing element 700 may comprise a compressive spring and/or an elastomeric material as discussed above. In some embodiments, such as that illustrated in FIG. 9, the tension biasing element 700 may be configured as a bent arm 702. The bent arm 702 can be configured such that as the chain 14 pushes downward on the bent arm 702 (such that it becomes compressed towards the bottom wall 105, the bent arm 702 inherently responds with an expansive force to return to its original position, thereby pushing outwardly against the chain 14).

With reference back to FIGS. 1 and 2, the chainsaw 10 may further include one or more additional features, such as to assist in the storage, handling, or operation of the chainsaw. For example, the illustrated chainsaw 10 also includes a protection sleeve 475 that is slidable along the longitudinal axis LA of the guide bar 100 to protect the chain 14 (e.g., during transportation of the chainsaw 10). In particular, the protection sleeve 475 includes an attachment portion 480 that extends over the cover assembly 270 for a detent 485 of the attachment portion 480 to engage the captured nut 280. Engagement between the captured nut 280 and the detent 485 maintains the protection sleeve 475 coupled to the guide bar 100. To remove the protection sleeve 475, the protection sleeve 475 is slid away from the housing 15 along the longitudinal axis LA of the guide bar 100 such that the detent 485 slides over the captured nut 280. In addition, the protection sleeve 475 includes at least one attachment member 490 extending from a periphery of the protection sleeve 475. In one embodiment, the attachment members 490 are operable to hang the chainsaw 10 from a wall, a worksite, etc. For example, the protection sleeve 475 can be coupled to an operator basket of a lift by the attachment members 490 for the operator within the operator basket to selectively support the chainsaw 10 on the operator basket.

Also, the housing 15 of the chainsaw 10 includes a hanging attachment 495 (e.g., a hook, a loop, etc.) pivotably coupled a bottom surface 57 of the battery pack receiving receptacle 55. The illustrated hanging attachment 495 is operable to support the chainsaw 10 when not in operation (e.g., a rope can be coupled to the hanging attachment 495, a hook can engage the hanging attachment 495, the chainsaw 10 can be supported on the operator basket by the hanging attachment, etc.).

Further aspects of the invention are provided by one or more of the following embodiments:

A chainsaw comprising a housing comprising a geartrain; a guide bar extending from the housing; a chain moveably coupled around the geartrain and the guide bar; a motive device operatively coupled to the geartrain that selectively drives the geartrain to cause rotational movement of the chain around the guide bar; a tension adjustment assembly configured to selectively move the guide bar relative to the housing to adjust a tension in the chain; and a tension biasing element that continuously imparts an expansive force on the guide bar and/or the chain to oppose a loosening of the tension in the chain.

The chainsaw of any one or more of the embodiments disclosed herein, wherein the expansive force of the tension biasing element pushes the guide bar away from the housing.

The chainsaw of any one or more of the embodiments disclosed herein, wherein the tension biasing element comprises a compression spring.

The chainsaw of any one or more of the embodiments disclosed herein, wherein the tension biasing element comprises an elastomeric material.

The chainsaw of any one or more of the embodiments disclosed herein, wherein the tension biasing element is disposed in the tension adjustment assembly.

The chainsaw of any one or more of the embodiments disclosed herein, wherein the expansive force of the tension biasing element pushes the chain away from the guide bar.

The chainsaw of any one or more of the embodiments disclosed herein, wherein the tension biasing element comprises a spring.

The chainsaw of any one or more of the embodiments disclosed herein, wherein the tension biasing element is disposed in the guide bar.

The chainsaw of any one or more of the embodiments disclosed herein, wherein the guide bar comprises on outer track comprising a first wall opposite a second wall, and a bottom wall extending between the first wall and the second wall; the chain is disposed in the outer track; and the tension biasing element is disposed in the outer track between the chain and the bottom wall.

The chainsaw of any one or more of the embodiments disclosed herein, wherein the tension adjustment assembly comprises a pin extending away from the housing and through an aperture in the guide bar; a worm gear threadably coupled to the pin; and an adjustment gear configured to selectively rotate the worm gear to move the pin relative to the housing.

The chainsaw of any one or more of the embodiments disclosed herein, wherein the tension biasing element is disposed between the pin and an end of the worm gear.

The chainsaw of any one or more of the embodiments disclosed herein, wherein the motive device comprises an electric motor.

The chainsaw of any one or more of the embodiments disclosed herein, further comprising a battery pack receiving receptacle.

A chainsaw includes a housing comprising a geartrain; a guide bar extending from the housing, the guide bar comprising an outer track comprising a first wall opposite a second wall, and a bottom wall extending between the first wall and the second wall; a chain moveably coupled around the geartrain and the outer track of the guide bar; a motive device operatively coupled to the geartrain that selectively drives the geartrain to cause rotational movement of the chain around the guide bar; and a tension adjustment assembly configured to selectively move the guide bar relative to the housing to adjust a tension in the chain. The tension adjustment assembly includes a pin extending away from the housing and through an aperture in the guide bar; a worm gear threadably coupled to the pin; and an adjustment gear configured to selectively rotate the worm gear to move the pin relative to the housing. The chainsaw further includes a tension biasing element that imparts an expansive force pushing the guide bar away from the housing to oppose a loosening of the tension in the chain.

The chainsaw of any one or more of the embodiments disclosed herein, wherein the tension biasing element is disposed between the pin and an end of the worm gear.

The chainsaw of any one or more of the embodiments disclosed herein, wherein the tension biasing element comprises a compressive spring.

The chainsaw of any one or more of the embodiments disclosed herein, wherein the tension biasing element comprises an elastomeric material.

A guide bar for a chainsaw includes an elongated body extending from a first end to a second end; an outer track disposed about the elongated body, wherein the outer track comprises a first wall opposite a second wall, and a bottom wall extending between the first wall and the second wall; and a tension biasing element disposed in the outer track, wherein the tension biasing element is configured to provide an expansive force between a chain and the bottom wall when the chain is disposed around the guide bar in the outer track to oppose a loosening of a tension in the chain.

The guide bar of any one or more of the embodiments disclosed herein, wherein the tension biasing element comprises a compressive spring.

The guide bar of any one or more of the embodiments disclosed herein, wherein the tension biasing element comprises a bent arm.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A chainsaw comprising:
a housing comprising a geartrain;
a guide bar extending from the housing;
a chain moveably coupled around the geartrain and the guide bar;
a motive device operatively coupled to the geartrain that selectively drives the geartrain to cause rotational movement of the chain around the guide bar;
a tension adjustment assembly configured to selectively move the guide bar relative to the housing to adjust a tension in the chain; and
a tension biasing element that continuously imparts an expansive force on the guide bar and/or the chain to oppose a loosening of the tension in the chain.

2. The chainsaw of claim 1, wherein the expansive force of the tension biasing element pushes the guide bar away from the housing.

3. The chainsaw of claim 2, wherein the tension biasing element comprises a compression spring.

4. The chainsaw of claim 2, wherein the tension biasing element comprises an elastomeric material.

5. The chainsaw of claim 2, wherein the tension biasing element is disposed in the tension adjustment assembly.

6. The chainsaw of claim 1, wherein the expansive force of the tension biasing element pushes the chain away from the guide bar.

7. The chainsaw of claim 6, wherein the tension biasing element comprises a spring.

8. The chainsaw of claim 6, wherein the tension biasing element is disposed in the guide bar.

9. The chainsaw of claim 6, wherein:
the guide bar comprises on outer track comprising a first wall opposite a second wall, and a bottom wall extending between the first wall and the second wall;
the chain is disposed in the outer track; and
the tension biasing element is disposed in the outer track between the chain and the bottom wall.

10. The chainsaw of claim 1, wherein the tension adjustment assembly comprises:
a pin extending away from the housing and through an aperture in the guide bar;
a worm gear threadably coupled to the pin; and
an adjustment gear configured to selectively rotate the worm gear to move the pin relative to the housing.

11. The chainsaw of claim 10, wherein the tension biasing element is disposed between the pin and an end of the worm gear.

12. The chainsaw of claim 1, wherein the motive device comprises an electric motor.

13. The chainsaw of claim 12, further comprising a battery pack receiving receptacle.

14. A chainsaw comprising:
a housing comprising a geartrain;
a guide bar extending from the housing, the guide bar comprising an outer track comprising a first wall opposite a second wall, and a bottom wall extending between the first wall and the second wall;
a chain moveably coupled around the geartrain and the outer track of the guide bar;
a motive device operatively coupled to the geartrain that selectively drives the geartrain to cause rotational movement of the chain around the guide bar;
a tension adjustment assembly configured to selectively move the guide bar relative to the housing to adjust a tension in the chain, the tension adjustment assembly comprising:
a pin extending away from the housing and through an aperture in the guide bar;
a worm gear threadably coupled to the pin; and
an adjustment gear configured to selectively rotate the worm gear to move the pin relative to the housing; and
a tension biasing element that imparts an expansive force pushing the guide bar away from the housing to oppose a loosening of the tension in the chain.

15. The chainsaw of claim 14, wherein the tension biasing element is disposed between the pin and an end of the worm gear.

16. The chainsaw of claim 15, wherein the tension biasing element comprises a compressive spring.

17. The chainsaw of claim 15, wherein the tension biasing element comprises an elastomeric material.

18. A guide bar for a chainsaw, the guide bar comprising:
an elongated body extending from a first end to a second end;
an outer track disposed about the elongated body, wherein the outer track comprises a first wall opposite a second wall, and a bottom wall extending between the first wall and the second wall; and
a tension biasing element disposed in the outer track, wherein the tension biasing element is configured to provide an expansive force between a chain and the bottom wall when the chain is disposed around the guide bar in the outer track to oppose a loosening of a tension in the chain.

19. The guide bar of claim 18, wherein the tension biasing element comprises a compressive spring.

20. The guide bar of claim 19, wherein the tension biasing element comprises a bent arm.
